(19) United States
(12) Patent Application Publication
(10) Pub. No.: US 2026/0238989 A1
(43) Pub. Date: Aug. 13, 2026

(54) METHOD FOR ACQUIRING SATELLITE COVERAGE INFORMATION, COMMUNICATION DEVICE, AND STORAGE MEDIUM

(71) Applicant: Beijing Xiaomi Mobile Software Co., Ltd., Beijing (CN)

(72) Inventor: Yuxin MAO, Beijing (CN)

(73) Assignee: Beijing Xiaomi Mobile Software Co., Ltd., Beijing (CN)

(21) Appl. No.: 19/155,174

(22) PCT Filed: Feb. 9, 2023
(86) PCT No.: PCT/CN2023/075299

§ 371 Date: Aug. 8, 2025

(51) Int. Cl. H04W 8/22; H04W 12/06; H04W 52/02; H04W 76/28; H04W 84/06

(52) U.S. Cl. CPC H04W 8/22; H04W 12/06; H04W 52/0235; H04W 76/28; H04W 84/06

(57) ABSTRACT

A method for acquiring satellite coverage information, including: determining a subject device for acquiring the satellite coverage information according to at least one of a capability of a user equipment (UE) or a capability of the network device, where the subject device is the UE or the network device, the capability of the UE includes a capability of the UE to acquire the satellite coverage information, and the capability of the network device includes a capability of the network device to acquire the satellite coverage information.

### CROSS-REFERENCE TO RELATED APPLICATION

The present application is a U.S. National Stage of International Application No. PCT/CN2023/075299, filed on Feb. 9, 2023, the contents of all of which are incorporated herein by reference in their entirety for all purposes.

### BACKGROUND OF THE INVENTION

In a case where a user equipment (UE) utilizes a satellite network, discontinuous coverage of the satellite network often occurs. Therefore, satellite coverage information needs to be determined, so that at least one of mobility management or power saving management may be performed on the UE according to the satellite coverage information.

### SUMMARY OF THE INVENTION

The present disclosure relates to the field of communication technologies, and in particular, to a method for acquiring satellite coverage information, a communication device, and a storage medium.

According to a first aspect of an embodiment of the present disclosure, a method for acquiring satellite coverage information is provided. The method includes:
determining a subject device for acquiring the satellite coverage information according to at least one of a capability of a user equipment (UE) or a capability of a network device, where the subject device is the UE or the network device, the capability of the UE includes a capability of the UE to acquire the satellite coverage information, and the capability of the network device includes a capability of the network device to acquire the satellite coverage information.

According to a second aspect of an embodiment of the present disclosure, a method for acquiring satellite coverage information is provided. The method includes:
transmitting second indication information to a network device, where the second indication information indicates a capability of a UE, the capability of the UE includes a capability of the UE to acquire the satellite coverage information, the second indication information instructs the network device to determine a subject device for acquiring the satellite coverage information, and the subject device is the UE or the network device.

According to a third aspect of an embodiment of the present disclosure, a communication device is provided. The communication device includes:
a processing module configured to determine a subject device for acquiring satellite coverage information according to at least one of a capability of a user equipment (UE) or a capability of a network device, where the subject device is the UE or the network device, the capability of the UE includes a capability of the UE to acquire the satellite coverage information, and a capability of the network device includes a capability of the network device to acquire the satellite coverage information.

According to a fourth aspect of an embodiment of the present disclosure, a communication device is provided. The communication device includes:
a transceiver module configured to transmit second indication information to a network device, where the second indication information indicates a capability of a UE, and the capability of the UE includes a capability of the UE to acquire satellite coverage information, the second indication information instructs the network device to determine a subject device for acquiring the satellite coverage information, and the subject device is the UE or the network device.

According to a fifth aspect of an embodiment of the present disclosure, a communication device is provided. The communication device includes one or more processors, where the one or more processors, when calling a computer program stored in a memory, perform the method according to the first aspect or the second aspect.

According to a sixth aspect of an embodiment of the present disclosure, a communication device is provided. The communication device includes one or more processors and a memory, and the memory stores a computer program. The computer program stored in the memory, when executed by the one or more processors, causes the communication device to perform the method according to the first aspect or the second aspect.

According to a seventh aspect of an embodiment of the present disclosure, a communication device is provided. The communication device includes one or more processors and an interface circuit. The interface circuit is configured to receive code instructions and transmit the code instructions to the processor. The one or more processors are collectively configured to run the code instructions to cause the communication device to perform the method according to the first aspect or the second aspect.

According to an eighth aspect of an embodiment of the present disclosure, a communication system is provided. The communication system includes the communication device according to the third aspect or the fourth aspect, the communication system includes the communication device according to the fifth aspect, the communication system includes the communication device according to the sixth aspect, or the communication system includes the communication device according to the seventh aspect.

According to a ninth aspect of an embodiment of the present disclosure, a non-transitory computer-readable storage medium is provided. The non-transitory computer-readable storage medium stores instructions used by a communication device. The instructions, when executed by one or more processors of the communication device, cause the communication device to perform the method according to the first aspect or the second aspect.

According to a tenth aspect of the present disclosure, a computer program product including a computer program is further provided. The computer program, when running on a computer, causes the computer to perform the method according to the first aspect or the second aspect.

According to an eleventh aspect of the present disclosure, a chip system is provided. The chip system includes at least one processor and an interface. The chip system is configured to support a communication device in implementing a function involved in the method according to the first aspect or the second aspect.

According to a twelfth aspect of the present disclosure, a computer program is provided. The computer program, when running on a computer, causes the computer to perform the method according to the first aspect or the second aspect.

### BRIEF DESCRIPTION OF DRAWINGS

The above and/or additional aspects and advantages of the present disclosure are apparent and easily understood from the following descriptions of embodiments with reference to accompanying drawings.

FIG. 1 is a schematic architectural diagram of a communication system according to an embodiment of the present disclosure.

FIG. 2a to FIG. 2f are schematic flowcharts of a method for acquiring satellite coverage information according to another embodiment of the present disclosure.

FIG. 3 is a schematic flowchart of a method for acquiring satellite coverage information according to another embodiment of the present disclosure.

FIG. 4 is a schematic flowchart of a method for acquiring satellite coverage information according to another embodiment of the present disclosure.

FIG. 5a and FIG. 5b are schematic flowcharts of a method for acquiring satellite coverage information according to another embodiment of the present disclosure.

FIG. 6a and FIG. 6b are schematic flowcharts of a method for acquiring satellite coverage information according to another embodiment of the present disclosure.

FIG. 7 is a schematic flowchart of a method for acquiring satellite coverage information according to another embodiment of the present disclosure.

FIG. 8 is a schematic flowchart of a method for acquiring satellite coverage information according to another embodiment of the present disclosure.

FIG. 9a and FIG. 9b are schematic flowcharts of a method for acquiring satellite coverage information according to another embodiment of the present disclosure.

FIG. 10a and FIG. 10b are schematic flowcharts of a method for acquiring satellite coverage information according to another embodiment of the present disclosure.

FIG. 11 is a schematic flowchart of a method for acquiring satellite coverage information according to another embodiment of the present disclosure.

FIG. 12 is a schematic flowchart of a method for acquiring satellite coverage information according to another embodiment of the present disclosure.

FIG. 13 is a schematic flowchart of a method for acquiring satellite coverage information according to another embodiment of the present disclosure.

FIG. 14 is a schematic flowchart of a method for acquiring satellite coverage information according to another embodiment of the present disclosure.

FIG. 15a and FIG. 15b are schematic flowcharts of a method for acquiring satellite coverage information according to another embodiment of the present disclosure.

FIG. 16 is a schematic flowchart of a method for acquiring satellite coverage information according to another embodiment of the present disclosure.

FIG. 17a to FIG. 17c are schematic flowcharts of a method for acquiring satellite coverage information according to another embodiment of the present disclosure.

FIG. 18a to FIG. 18c are schematic flowcharts of a method for acquiring satellite coverage information according to another embodiment of the present disclosure.

FIG. 19 is a schematic flowchart of a method for acquiring satellite coverage information according to another embodiment of the present disclosure.

FIG. 20 is a schematic flowchart of a method for acquiring satellite coverage information according to another embodiment of the present disclosure.

FIG. 21 is a schematic flowchart of a method for acquiring satellite coverage information according to another embodiment of the present disclosure.

FIG. 22 is a schematic flowchart of a method for acquiring satellite coverage information according to another embodiment of the present disclosure.

FIG. 23 is a schematic structural diagram of a communication device according to another embodiment of the present disclosure.

FIG. 24 is a schematic structural diagram of a communication device according to another embodiment of the present disclosure.

FIG. 25 is a schematic structural diagram of a communication device according to an embodiment of the present disclosure.

FIG. 26 is a schematic structural diagram of a chip according to an embodiment of the present disclosure.

### DETAILED DESCRIPTION OF THE INVENTION

Embodiments are described in detail in the disclosure, and examples are shown in the accompanying drawings. When the following descriptions are related to accompanying drawings, unless otherwise stated, the same numbers in different accompanying drawings represent the same or similar elements. Implementations described in the following examples do not represent all implementations consistent with embodiments of the present disclosure. Instead, the implementations are merely examples of devices and methods that are consistent with some aspects of embodiments of the present disclosure, as detailed in the appended claims.

Terms used in embodiments of the present disclosure are merely intended to describe particular embodiments, but are not intended to limit embodiments of the present disclosure. The singular forms “a” and “the” used in embodiments of the present disclosure and the appended claims are intended to include the plural forms, unless otherwise clearly stated in the context. It is to be further understood that the term “and/or” used in the specification refers to and includes any or all possible combinations of one or more of the listed associated items.

It is to be understood that, although the terms first, second, third, and the like may be used for describing various information in embodiments of the present disclosure, the information is not limited to these terms. These terms are used only to distinguish signals of a same type from one another. For example, without departing from the scope of embodiments of the present disclosure, first information may alternatively be referred to as second information, and similarly, second information may alternatively be referred to as first information. Depending on the context, terms “when” and “if” as used in the disclosure may be interpreted as “when,” “in a case where,” or “in response to determining”.

Embodiments of the present disclosure are described in detail, and examples of embodiments are illustrated in the accompanying drawings, where the same or similar reference numerals indicate same or similar elements throughout. Embodiments described with reference to the accompanying drawings are examples and are intended to be used to explain the present disclosure, but are not to be construed as limiting the present disclosure.

For ease of understanding, terms involved in the present disclosure are first introduced.
1. Access and mobility management function (AMF) network element

The access and mobility management function network element supports a terminal with different mobility management requirements. The following major tasks may be performed: non-access stratum (NAS) signaling terminal; NAS signaling security; access stratum security control; core network node signaling for mobility between 3rd generation partnership project (3GPP) access networks; terminal reachability in an idle mode (including control and execution of paging and retransmission); registration area management; support for intra-system and inter-system mobility; access authentication; access authorization, including roaming permission check; mobility management control (subscription and policy); support for network slicing; and session management function (SMF) selection.

The AMF network element, the NAS signaling, the 3GPP, and the SMF are examples of descriptions of the present disclosure. These names are not limited to the present disclosure, and another network element that may implement similar functions also falls within the protection scope of the present disclosure.
2. Application function (AF)

The AF may be configured to provide an application with the fifth generation (5G) network capabilities. The application acquires exposure capabilities through an interface provided by a network exposure function (NEF) network element to the AF.

The AF and the NEF are example descriptions of the present disclosure. These names are not limited to the present disclosure, and another network element that may implement similar functions also falls within the protection scope of the present disclosure.

In a communication system, in a case where a user equipment (UE) utilizes a satellite network, signal coverage provided by a satellite to the ground may be discontinuous due to factors such as an insufficient quantity of satellites in a starlink or discontinuous satellite beams. For example, in a case where the UE accesses a network via a satellite in a specific area, the UE may have no satellite signal coverage within a specific period of time. In some examples, in a case where the UE has no satellite signal coverage, power saving management may be performed on the UE, for example, enabling the UE switch to a power saving mode (where the power saving mode may be understood as that the UE does not communicate or interact with a network device), and making the network device suspend transmitting signaling/data to the UE to reduce power consumption. In a case where the satellite signal coverage resumes, mobility management may be performed on the UE, allowing the UE to re-establish a connection with the network and engage in services by communicating and interacting with each other. Therefore, in the communication system, the UE and the network device need to determine a UE unreachability period (i.e., the period without signal coverage) to generate corresponding management information according to the UE unreachability period, which is used for power saving management and mobility management. In some examples, in a case where the UE unreachability period is determined, satellite coverage information of the satellite network at a specified location (such as a current location of the UE) generally needs to be first acquired, and then the UE unreachability period is determined according to the satellite coverage information and at least one of a location of the UE or a movement trajectory of the UE.

Based on this, the present disclosure provides a method for acquiring satellite coverage information.

To better understand the method for acquiring satellite coverage information disclosed in embodiments of the present disclosure, a communication system to which embodiments of the present disclosure are applicable is described.

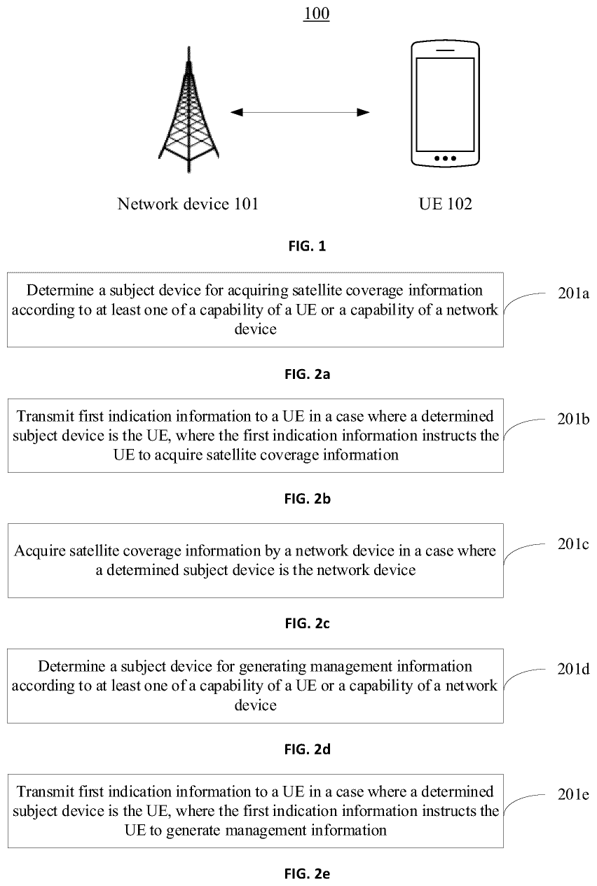

FIG. 1 is a schematic architectural diagram of a communication system 100 according to an embodiment of the present disclosure. The communication system 100 may include, but is not limited to, a network device 101 and a UE 102. In some examples, a quantity and a form of devices shown in FIG. 1 are used as an example and do not constitute a limitation on this embodiment of the present disclosure. In actual application, one or more network devices 101 and one or more UEs 102 may be included. In some examples, for example, the communication system 100 shown in FIG. 1 may include a network device 101 and a UE 102.

It is to be noted that, the technical solutions provided in embodiments of the present disclosure may be applied to various communication systems, for example, a long-term evolution (LTE) system, a fifth generation (5G) mobile communication system, a 5G new radio (NR) system, or another future new mobile communication system.

The UE in embodiments of the present disclosure may be an entity on a user side for signal receiving or transmission, for example, a mobile phone. The UE may alternatively be referred to as a terminal, a user equipment (UE), a mobile station (MS), a mobile terminal (MT), or the like. The UE may be a car with a communication function, a smart car, a mobile phone, a wearable device, a tablet computer (Pad), a computer with a wireless transceiver function, a virtual reality (VR) terminal, an augmented reality (AR) terminal, a wireless terminal in industrial control, a wireless terminal in self-driving, a wireless terminal in a remote medical surgery, a wireless terminal in a smart grid, a wireless terminal in transportation safety, a wireless terminal in a smart city, a wireless terminal in a smart home, or the like. A specific technology and a specific device form configured for the UE are not limited to embodiments of the present disclosure.

The network device in embodiments of the present disclosure may be a core network device. In some examples, the core network device may be a device deployed in a core network. Primary functions of the core network device include providing user connectivity, user management, and service bearing, and providing an interface to an external network as a bearer network. For example, the core network device in a 5G NR system may include at least one of an access and mobility management function (AMF) network element, a user plane function (UPF) network element, a session management function (SMF) network element, a mobility management entity (MME), or the like.

It may be understood that the communication system described in embodiments of the present disclosure is intended to describe the technical solutions in embodiments of the present disclosure more clearly, and does not constitute a limitation on the technical solutions provided in embodiments of the present disclosure. A person of ordinary skill in the art may learn that, with evolution of a system architecture and emergence of a new service scenario, the technical solutions provided in embodiments of the present disclosure are also applicable to similar technical problems.

The following describes a method for acquiring satellite coverage information, a communication device, and a storage medium provided in embodiments of the present disclosure in detail with reference to accompanying drawings.

It is to be noted that, in the present disclosure, without contradiction, each step in any one of the implementations or embodiments may be implemented as an independent embodiment, and the steps may be randomly combined. For example, a solution that removes certain steps from a specific implementation or embodiment may alternatively be implemented as an independent embodiment, and the sequence of steps in a specific implementation or embodiment may be randomly rearranged. In addition, optional methods or optional examples in a specific implementation or embodiment may be randomly combined. In addition, the implementations or embodiments may be randomly combined. For example, some or all steps of different implementations or embodiments may be randomly combined, and a specific implementation or embodiment may be randomly combined with an optional method or an optional example of another implementation or embodiment. Regarding the description methods of the present disclosure such as “A or B,” “A and/or B,” “at least one of A or B,” “A in a case, and B in another case,” “in response to one case A, and in response to another case B,” and the like, at least one of the following solutions may be included according to the situation: performing A independently of B, that is, A in some implementations; performing B independently of A, that is, B in some implementations; selectively performing A and B, that is, selecting to perform A or B in some implementations; or performing both A and B, that is, A and B in some implementations. In addition, each element, each row, or each column in a table in the present disclosure may be implemented as an independent embodiment, and a combination of any elements, any rows, and any columns may also be implemented as an independent embodiment.

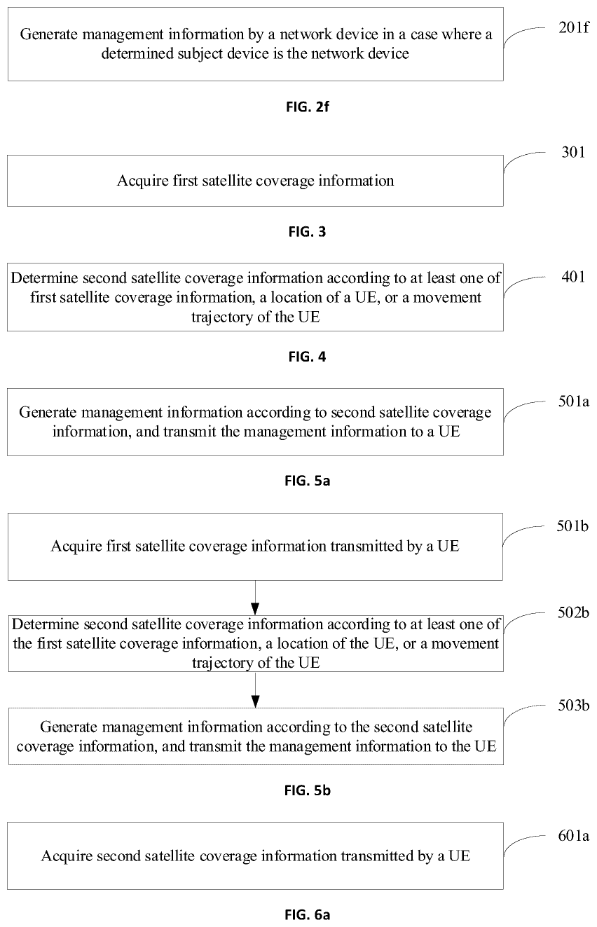

FIG. 2a is a schematic flowchart of a method for acquiring satellite coverage information according to an embodiment of the present disclosure. The method is performed by a network device. As shown in FIG. 2a, the method for acquiring the satellite coverage information may include step 201a.

In step 201a, a subject device for acquiring the satellite coverage information is determined according to at least one of a capability of a UE or a capability of the network device.

In some examples, in an embodiment of the present disclosure, the network device may include at least one of the following:
an access and mobility management function (AMF);
a session management function (SMF); or
a mobility management entity (MME).

In some examples, in an embodiment of the present disclosure, the capability of the UE may include a capability of the UE to acquire satellite coverage information, and the capability of the network device may include a capability of the network device to acquire the satellite coverage information.

In some examples, in an embodiment of the present disclosure, the capability of the UE may be indicated by the UE to the network device. In some examples, in a case where the UE supports satellite coverage information acquisition, the UE may transmit second indication information to the network device, to indicate that the UE supports the capability of acquiring the satellite coverage information. In some examples, the second indication information may be carried in at least one of a registration request, a registration update request, a service request message, or a protocol data unit (PDU) session (for example, at least one of a PDU session establishment message or a PDU session modification message) and then transmitted to the network device.

In some examples, in an embodiment of the present disclosure, the satellite coverage information may include at least one of first satellite coverage information or second satellite coverage information. The first satellite coverage information may indicate satellite signal coverage of a satellite network. For example, the first satellite coverage information may indicate at least one of the following: satellite signal coverage of a satellite network currently accessed by the UE, or satellite signal coverage of at least one available satellite network. In some examples, the first satellite coverage information may include at least one of third indication information or fourth indication information. The third indication information indicates satellite signal coverage of the satellite network at each time point, where the satellite network may be, for example, at least one of the satellite network currently accessed by the UE or at least one available satellite network. The fourth indication information indicates whether the satellite network has satellite signal coverage at a specified location at each time point, where the specified location may be, for example, a current location of the UE, or a specific location of the UE at a future time point. In some examples, the second satellite coverage information may indicate satellite signal coverage of the UE. In some examples, in an embodiment of the present disclosure, the second satellite coverage information may indicate satellite coverage of the UE at a specified location. For example, in an embodiment of the present disclosure, the second satellite coverage information may indicate coverage information of the UE at a current location. In some examples, in an embodiment of the present disclosure, the second satellite coverage information may include, for example, at least one of the following information: a time point at which the UE has satellite signal coverage; a period in which the UE has the satellite signal coverage; a time point at which the UE has no satellite signal coverage; or a period in which the UE has no satellite signal coverage. In some embodiments, the second satellite coverage information may be UE-related satellite coverage information.

In some examples, the satellite coverage information, the first satellite coverage information, the second satellite coverage information, and the satellite network coverage information mentioned in embodiments of the present disclosure are merely names provided by the present disclosure and may alternatively be expressed in other words. This is not limited in the present disclosure.

In some examples, in an embodiment of the present disclosure, the determined subject device for acquiring satellite coverage information may be the UE or the network device. In some examples, determining the subject device for acquiring the satellite coverage information according to at least one of the capability of the UE or the capability of the network device may include at least one of the following:
determining that the subject device for acquiring the satellite coverage information is the UE in a case where the UE supports acquiring the satellite coverage information and the network device does not support acquiring the satellite coverage information;
determining that the subject device for acquiring the satellite coverage information is the network device in a case where the UE does not support acquiring the satellite coverage information and the network device supports acquiring the satellite coverage information; or
determining that the subject device for acquiring the satellite coverage information is the network device or the UE in a case where the UE supports acquiring the satellite coverage information and the network device supports acquiring the satellite coverage information.

In some examples, in an embodiment of the present disclosure, the network device may further determine the subject device for acquiring the first satellite coverage information according to at least one of the capability of the UE or the capability of the network device.

In some examples, in another embodiment of the present disclosure, the network device may further determine the subject device for acquiring the second satellite coverage information according to at least one of the capability of the UE or the capability of the network device.

In some examples, in this implementation or embodiment, without contradiction, each step may be independent, randomly combined, or exchanged in order, and optional methods or optional examples may be randomly combined and may be randomly combined with another implementation or embodiment.

In conclusion, in the method for acquiring the satellite coverage information according to embodiments of the present disclosure, the network device determines the subject device for acquiring the satellite coverage information from the network device and the UE according to at least one of the capability of the UE or the capability of the network device. Therefore, the satellite coverage information may be subsequently acquired according to a decision result, to ensure the successful acquisition of the satellite coverage information, and to ensure that management information may be successfully generated according to the satellite coverage information subsequently, and then to ensure that at least one of power saving management or mobility management may be successfully performed according to the management information, accordingly reducing power consumption.

FIG. 2b is a schematic flowchart of a method for acquiring satellite coverage information according to an embodiment of the present disclosure. The method is performed by a network device. As shown in FIG. 2b, the method for acquiring the satellite coverage information may include step 201b.

In step 201b, first indication information is transmitted to a UE in a case where a determined subject device is the UE, where the first indication information instructs the UE to acquire the satellite coverage information.

In some examples, in an embodiment of the present disclosure, the first indication information may indicate the UE to acquire first satellite coverage information and to transmit the acquired first satellite coverage information to the network device. In some examples, in an embodiment of the present disclosure, after acquiring the first satellite coverage information transmitted by the UE, the network device may subsequently determine second satellite coverage information according to at least one of the first satellite coverage information, a location of the UE, or a movement trajectory of the UE, and then determine management information according to the second satellite coverage information, and then transmit the management information to the UE.

In some examples, in an embodiment of the present disclosure, the location of the UE may be requested by the network device from the UE or an access network device (for example, a base station). The movement trajectory of the UE may be requested by the network device from a network data analytics function (NWDAF).

In some examples, in an embodiment of the present disclosure, the management information may enable the UE to maintain different modes within different satellite signal coverage of the UE. In some examples, in an embodiment of the present disclosure, the management information may be configured for performing power saving management on the UE during a period in which the UE has no satellite signal coverage and for performing mobility management on the UE during a period in which the UE has the satellite signal coverage. In some examples, the power saving management may be, for example, understood as: enabling the UE to maintain a power saving mode during a period without satellite signal coverage. The mobility management may be, for example, understood as: waking up the UE from the power saving mode to a network connection state during a period with the satellite signal coverage. For example, in an embodiment of the present disclosure, the management information may enable the UE to maintain the power saving mode during the period without satellite signal coverage and to maintain the network connection state during the period with the satellite signal coverage. In some examples, in some implementations, the management information may be a power saving parameter and timing duration of a non-access stratum (NAS) timer. In some examples, the management information mentioned in embodiments of the present disclosure is merely a name provided by the present disclosure and may alternatively be expressed in other words. This is not limited to the present disclosure.

In some examples, in an embodiment of the present disclosure, the management information may include at least one of the following:
an extended discontinuous reception (eDRX) parameter in a connection management idle state (CM-IDLE);
a parameter for configuring a mobile initiated connection only (MICO) mode;
a parameter for configuring a power saving mode (PSM); or
timing duration of a periodic registration timer.

In some examples, in an embodiment of the present disclosure, the eDRX parameter includes an eDRX cycle and a paging time window (PTW), and the eDRX cycle and the PTW may be set according to the second satellite coverage information. In some examples, in a case where the UE is configured with the eDRX parameter, the UE switches to the power saving mode according to the eDRX cycle and the PTW. For example, the UE may be paged and awakened by the network device within the PTW in each eDRX cycle to resume connection for engaging in services, and the terminal remains in the power saving mode without engaging in services for the rest of time.

In some examples, in an embodiment of the present disclosure, the parameter for configuring the MICO mode may include activation time, the activation time may be set according to the second satellite coverage information, and the activation time may include the period in which the UE has the satellite signal coverage. In some examples, in a case where the UE is configured with the activation time, the UE may be paged by the network device during the activation time and engage in services through communication with the network device, and the UE remains in the power saving mode for the rest of time.

In some examples, in an embodiment of the present disclosure, the parameter for configuring the PSM mode may include activation time and a periodic tracking area update (TAU) timer. The activation time and the TAU timer may be set according to the second satellite coverage information. The activation time may include the period in which the UE has the satellite signal coverage, and the timing duration of the TAU timer may include the period in which the UE has no satellite signal coverage. In some examples, in a case where the UE is configured with the activation time and the TAU timer, the UE may be paged by the network device during the activation time and engage in services through communication with the network device. After the activation time expires, the periodic TAU timer may be started. During the operation of the periodic TAU timer, the terminal remains in the power saving mode without engaging in services. In a case where the periodic TAU timer expires, it is considered that the activation time has been started again, and in this case, the UE may be paged by the network device and engage in services through communication with the network device.

In some examples, in an embodiment of the present disclosure, the periodic registration timer may be configured for starting the periodic registration timer in a case where the UE begins to have no signal coverage, and during the operation of the periodic registration timer, the UE remains in the power saving mode and does not communicate or interact with the network device; or in a case where the periodic registration timer expires, the UE requests a registration update to the network device to establish a communication connection.

In some examples, in another embodiment of the present disclosure, the first indication information may indicate the UE to acquire the first satellite coverage information; determine the second satellite coverage information according to at least one of the first satellite coverage information, the location of the UE, or the movement trajectory of the UE; and then transmit the determined second satellite coverage information to the network device. In some examples, in an embodiment of the present disclosure, after acquiring the second satellite coverage information transmitted by the UE, the network device may determine the management information according to the second satellite coverage information and transmit the management information to the UE, to implement at least one of power management or mobility management on the UE.

In some examples, in another embodiment of the present disclosure, the first indication information may indicate the UE to acquire the first satellite coverage information, determine the second satellite coverage information according to at least one of the first satellite coverage information, the location of the UE, or the movement trajectory of the UE, then determine the management information according to the second satellite coverage information, and then transmit the determined management information to the network device. In some examples, in an embodiment of the present disclosure, after acquiring the management information transmitted by the UE, the network device may perform authorization on the management information transmitted by the UE, and transmit the management information to the UE in a case where the authorization passes, to implement at least one of power saving management or mobility management on the UE.

In some examples, in an embodiment of the present disclosure, the first indication information may be carried in at least one of a registration response, a registration update response, a PDU session establishment response, a PDU session modification response, or a user configuration update and then transmitted to the UE.

In some examples, in an embodiment of the present disclosure, the first indication information is transmitted to the UE in a case where a subject device for acquiring the first satellite coverage information is the UE, where the first indication information indicates the UE to acquire the first satellite coverage information.

In some examples, in another embodiment of the present disclosure, the first indication information is transmitted to the UE in a case where a subject device for acquiring the second satellite coverage information is the UE, where the first indication information indicates the UE to acquire the second satellite coverage information.

In some examples, in the present disclosure, without contradiction, each step may be independent, randomly combined or exchanged in order, and optional methods or optional examples may be randomly combined and may be randomly combined with another implementation or embodiment.

In conclusion, in the method for acquiring satellite coverage information according to embodiments of the present disclosure, in a case where the network device determines that the UE is to acquire the satellite coverage information, the network device transmits the first indication information to the UE, where the first indication information may indicate the UE to acquire the satellite coverage information. Therefore, after the UE acquires the first indication information, the UE may determine at least one of the first satellite coverage information or the second satellite coverage information, or the UE may generate the management information according to at least one of the first satellite coverage information or the second satellite coverage information, and then the UE may transmit at least one of the first satellite coverage information, the second satellite coverage information, or the management information to the network device. Therefore, the network device may finally generate the management information according to at least one of the acquired first satellite coverage information or the acquired second satellite coverage information, or the network device may perform the authorization on the acquired management information, to ensure that at least one of power saving management or mobility management may be successfully performed according to the management information subsequently, accordingly reducing power consumption.

FIG. 2c is a schematic flowchart of a method for acquiring satellite coverage information according to an embodiment of the present disclosure. The method is performed by a network device. As shown in FIG. 2c, the method for acquiring the satellite coverage information may include step 201c.

In step 201c, the network device acquires the satellite coverage information in a case where a determined subject device is the network device.

In some examples, in an embodiment of the present disclosure, the satellite coverage information (that is, at least one of the foregoing first satellite coverage information or the foregoing second satellite coverage information) may be requested by the network device from at least one of an AF or a management server responsible for satellite operation information.

In some examples, in an embodiment of the present disclosure, the network device acquires the satellite coverage information, which may include at least one of the following.

The network device acquires the first satellite coverage information. In some examples, after acquiring the first satellite coverage information, the network device may generate the second satellite coverage information according to at least one of the first satellite coverage information, a location of the UE, or a movement trajectory of the UE, then generate management information according to the second satellite coverage information, and transmit the generated management information to the UE for at least one of power saving management or mobility management on the UE.

The network device acquires the second satellite coverage information. In some examples, after acquiring the second satellite coverage information, the network device may generate the management information according to the second satellite coverage information, and transmit the generated management information to the UE for at least one of power saving management or mobility management on the UE.

In some examples, in an embodiment of the present disclosure, the network device acquires the first satellite coverage information in a case where a subject device for acquiring the first satellite coverage information is the network device.

In some examples, in another embodiment of the present disclosure, the network device acquires the second satellite coverage information in a case where a subject device for acquiring the second satellite coverage information is the network device.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, in a case where the network device determines that the network device is to acquire the satellite coverage information, the network device acquires at least one of the first satellite coverage information or the second satellite coverage information. Therefore, the network device may finally generate the management information according to at least one of the acquired first satellite coverage information or the acquired second satellite coverage information and then transmit the management information to the network device, to ensure that at least one of power saving management or mobility management may be successfully performed according to the management information, accordingly reducing power consumption.

FIG. 2d is a schematic flowchart of a method for acquiring satellite coverage information according to an embodiment of the present disclosure. The method is performed by a network device. As shown in FIG. 2d, the method for acquiring the satellite coverage information may include step 201d.

In step 201d, a subject device for generating management information is determined according to at least one of a capability of a UE or a capability of the network device.

For descriptions of the step 201d, refer to the content of the step 201a.

In this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device determines the subject device for generating the management information from the network device and the UE according to at least one of the capability of the UE or the capability of the network device, to successfully generate the management information, so that at least one of power saving management or mobility management may be successfully performed according to the management information subsequently, accordingly reducing power consumption.

FIG. 2e is a schematic flowchart of a method for acquiring satellite coverage information according to an embodiment of the present disclosure. The method is performed by a network device. As shown in FIG. 2e, the method for acquiring the satellite coverage information may include step 201e.

In step 201e, first indication information is transmitted to a UE in a case where a determined subject device is the UE, where the first indication information instructs the UE to generate management information.

For descriptions of the step 201e, refer to the content of the step 201b.

In this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, in a case where the network device determines that the UE is to generate the management information, the network device transmits the first indication information to the UE, and the first indication information may indicate the UE to generate the management information. Therefore, after acquiring the first indication information, the UE may generate the management information and then transmit the management information to the network device, so that the network device may perform authorization on the management information, and then transmit the management information to the UE in a case where the authorization passes, to ensure that at least one of power saving management or mobility management may be successfully performed according to the management information subsequently, accordingly reducing power consumption.

FIG. 2f is a schematic flowchart of a method for acquiring satellite coverage information according to an embodiment of the present disclosure. The method is performed by a network device. As shown in FIG. 2f, the method for acquiring the satellite coverage information may include step 201f.

In step 201f, the network device generates management information in a case where a determined subject device is the network device.

For descriptions of the step 201f, refer to the content of the step 201c.

In this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, in a case where the network device determines the network device is to generate the management information, the network device generates the management information, so that the network device may transmit the management information to the UE, and at least one of power saving management or mobility management may be successfully performed on the UE according to the management information, accordingly reducing power consumption.

FIG. 3 is a schematic flowchart of a method for acquiring satellite coverage information according to an embodiment of the present disclosure. The method is performed by a network device. As shown in FIG. 3, the method for acquiring the satellite coverage information may include step 301.

In step 301, first satellite coverage information transmitted by a UE is acquired.

In some examples, in an embodiment of the present disclosure, the UE may request to acquire the first satellite coverage information from at least one of an AF or a management server responsible for satellite operation information and then transmit the first satellite coverage information to the network device.

For detailed descriptions of the step 301, refer to the content of the step 201a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device acquires the first satellite coverage information transmitted by the UE, and then the network device may finally generate management information according to the first satellite coverage information and transmit the management information to the UE, so that at least one of power saving management or mobility management may be successfully performed on the UE, accordingly reducing power consumption.

FIG. 4 is a schematic flowchart of a method for acquiring satellite coverage information according to an embodiment of the present disclosure. The method is performed by a network device. As shown in FIG. 4, the method for acquiring the satellite coverage information may include step 401.

In step 401, second satellite coverage information is determined according to at least one of first satellite coverage information, a location of a UE, or a movement trajectory of a UE.

For detailed descriptions of the step 401, refer to the content of the step 201b.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device generates the second satellite coverage information according to the first satellite coverage information, so that the network device may successfully generate management information according to the second satellite coverage information and then transmit the management information to the UE, to perform at least one of power saving management or mobility management on the UE, accordingly reducing power consumption.

FIG. 5a is a schematic flowchart of a method for acquiring satellite coverage information according to an embodiment of the present disclosure. The method is performed by a network device. As shown in FIG. 5a, the method for acquiring the satellite coverage information may include step 501a.

In step 501a, management information is generated according to second satellite coverage information, and the management information is transmitted to a UE.

For detailed descriptions of the step 501a, refer to the content of the step 201a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device may generate the management information according to the second satellite coverage information and then transmit the management information to the UE, so that at least one of power saving management or mobility management may be successfully performed on the UE according to the management information, accordingly reducing power consumption.

FIG. 5b is a schematic flowchart of a method for acquiring satellite coverage information according to an embodiment of the present disclosure. The method is performed by a network device. As shown in FIG. 5b, the method for acquiring the satellite coverage information may include steps 501b to 503b.

In step 501b, first satellite coverage information transmitted by a UE is acquired.

In step 502b, second satellite coverage information is determined according to at least one of the first satellite coverage information, a location of the UE, or a movement trajectory of the UE.

In step 503b, management information is generated according to the second satellite coverage information, and the management information is transmitted to the UE.

For detailed descriptions of the steps 501b to 503b, refer to the content of the embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device may acquire the first satellite coverage information, finally generate the management information according to the first satellite coverage information, and then transmit the management information to the UE, so that at least one of power saving management or mobility management may be successfully performed on the UE according to the management information, accordingly reducing power consumption.

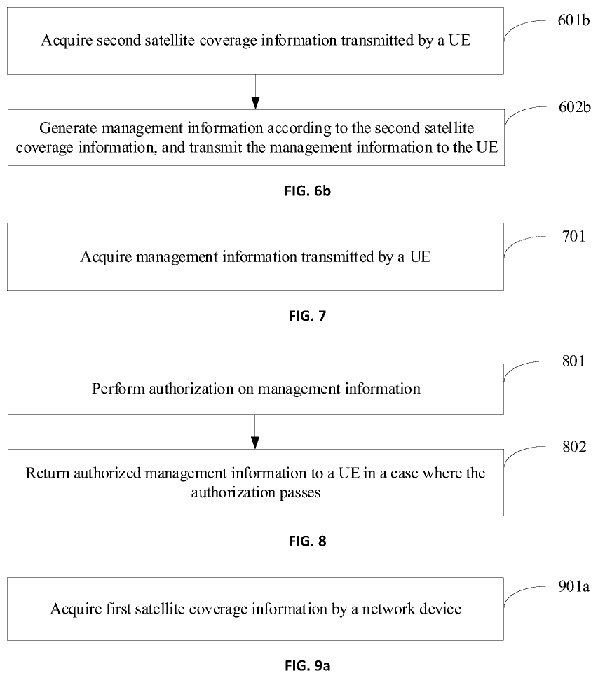

FIG. 6a is a schematic flowchart of a method for acquiring satellite coverage information according to an embodiment of the present disclosure. The method is performed by a network device. As shown in FIG. 6a, the method for acquiring the satellite coverage information may include step 601a.

In step 601a, second satellite coverage information transmitted by a UE is acquired.

In some examples, in an embodiment of the present disclosure, the UE may request to acquire first satellite coverage information from at least one of an AF or a management server responsible for satellite operation information, then determine the second satellite coverage information according to the first satellite coverage information, and then transmit the determined second satellite coverage information to the network device. Alternatively, the UE may directly request the second satellite coverage information from at least one of the AF or the management server responsible for the satellite operation information, and then transmit the acquired second satellite coverage information to the network device.

For detailed descriptions of the step 601a, refer to the content of the step 201b in the embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device acquires the second satellite coverage information transmitted by the UE, so that the network device may finally generate the management information according to the second satellite coverage information and then transmit the management information to the UE, so that at least one of power saving management or mobility management may be successfully performed on the UE, accordingly reducing power consumption.

FIG. 6b is a schematic flowchart of a method for acquiring satellite coverage information according to an embodiment of the present disclosure. The method is performed by a network device. As shown in FIG. 6b, the method for acquiring the satellite coverage information may include steps 601b and 602b.

In step 601b, second satellite coverage information transmitted by a UE is acquired.

In step 602b, management information is generated according to the second satellite coverage information, and the management information is transmitted to the UE.

For detailed descriptions of the steps 601b to 602b, refer to the content of embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device may generate the management information according to the second satellite coverage information and then transmit the management information to the UE, so that at least one of power saving management or mobility management may be successfully performed on the UE according to the management information, accordingly reducing power consumption.

FIG. 7 is a schematic flowchart of a method for acquiring satellite coverage information according to an embodiment of the present disclosure. The method is performed by a network device. As shown in FIG. 7, the method for acquiring the satellite coverage information may include step 701.

In step 701, management information transmitted by a UE is acquired.

For detailed descriptions of the step 701, refer to the content of the step 201a in the embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device acquires the management information transmitted by the UE, so that the network device may perform authorization on the management information, and then return the management information to the network device in a case where the authorization passes, so that at least one of power saving management or mobility management may be performed on the UE, accordingly reducing power consumption.

FIG. 8 is a schematic flowchart of a method for acquiring satellite coverage information according to an embodiment of the present disclosure. The method is performed by a network device. As shown in FIG. 8, the method for acquiring the satellite coverage information may include steps 801 and 802.

In step 801, authorization is performed on management information.

In step 802, authorized management information is returned to a UE in a case where the authorization passes.

In some examples, in an embodiment of the present disclosure, the authorized management information returned by the network device to the UE may be same or different from the management information transmitted by the UE to the network device.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device acquires the management information transmitted by the UE, performs authorization on the management information transmitted by the UE, and then transmits the authorized management information to the UE, so that at least one of power saving management or mobility management may be successfully performed on the UE, accordingly reducing power consumption.

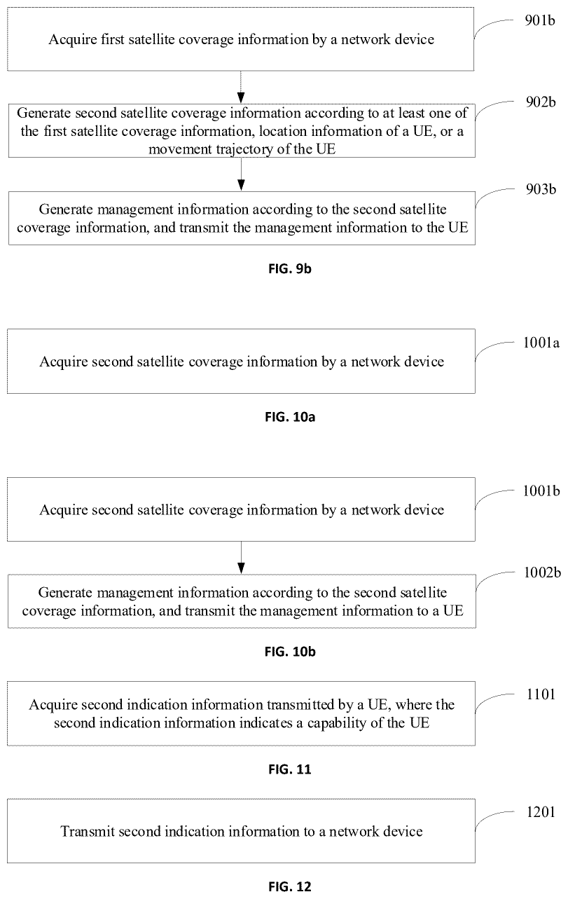

FIG. 9a is a schematic flowchart of a method for acquiring satellite coverage information according to an embodiment of the present disclosure. The method is performed by a network device. As shown in FIG. 9a, the method for acquiring the satellite coverage information may include step 901a.

In step 901a, the network device acquires first satellite coverage information.

For detailed descriptions of the step 901a, refer to the content of embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device determines that the network device is to acquire the first satellite coverage information. Therefore, the network device generates the management information according to the acquired first satellite coverage information, and then transmits the management information to the UE, so that at least one of power saving management or mobility management may be successfully performed on the UE according to the management information, accordingly reducing power consumption.

FIG. 9b is a schematic flowchart of a method for acquiring satellite coverage information according to an embodiment of the present disclosure. The method is performed by a network device. As shown in FIG. 9b, the method for acquiring the satellite coverage information may include steps 901b to 903b.

In step 901b, the network device acquires first satellite coverage information.

In step 902b, second satellite coverage information is generated according to at least one of the first satellite coverage information, a location information of a UE, or a movement trajectory of the UE.

In step 903b, management information is generated according to the second satellite coverage information, and the management information is transmitted to the UE.

For detailed descriptions of the steps 901b to 903b, refer to the content of embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device may acquire the first satellite coverage information, finally generate the management information according to the first satellite coverage information, and then transmit the management information to the UE, so that at least one of power saving management or mobility management may be successfully performed on the UE according to the management information, accordingly reducing power consumption.

FIG. 10a is a schematic flowchart of a method for acquiring satellite coverage information according to an embodiment of the present disclosure. The method is performed by a network device. As shown in FIG. 10a, the method for acquiring the satellite coverage information may include the following step 1001a.

In step 1001a, the network device acquires second satellite coverage information.

For detailed descriptions of the step 1001a, refer to the content of embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device determines that the network device is to acquire the second satellite coverage information, so that the network device generates the management information according to the acquired second satellite coverage information, and then transmits the management information to the UE, so that at least one of power saving management or mobility management may be successfully performed on the UE according to the management information, accordingly reducing power consumption.

FIG. 10b is a schematic flowchart of a method for acquiring satellite coverage information according to an embodiment of the present disclosure. The method is performed by a network device. As shown in FIG. 10b, the method for acquiring the satellite coverage information may include steps 1001b and 1002b.

In step 1001b, the network device acquires second satellite coverage information.

In step 1002b, management information is generated according to the second satellite coverage information, and the management information is transmitted to a UE.

For detailed descriptions of the steps 1001b to 1002b, refer to the content of the embodiment in FIG. 2.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the network device may acquire the first satellite coverage information, finally generate the management information according to the first satellite coverage information, and then transmit the management information to the UE, so that at least one of power saving management or mobility management may be successfully performed on the UE according to the management information, accordingly reducing power consumption.

FIG. 11 is a schematic flowchart of a method for acquiring satellite coverage information according to an embodiment of the present disclosure. The method is performed by a network device, as shown in FIG. 11.

In step 1101, second indication information transmitted by a UE is acquired, where the second indication information indicates a capability of the UE.

In some examples, in an embodiment of the present disclosure, after acquiring the second indication information transmitted by the UE, the network device may determine the capability of the UE according to the second indication information, so that the subject device for acquiring the satellite coverage information may be determined according to at least one of the capability of the UE or a capability of the network device.

For detailed descriptions of the step 1101, refer to the content of embodiment in FIG. 2a.

In some examples, in this implementation or embodiment, without contradiction, each step may be independent, randomly combined or exchanged in order, and may be randomly combined with another implementation or embodiment.

In conclusion, in the method for acquiring the satellite coverage information according to embodiments of the present disclosure, the network device determines that the network device is to acquire the second satellite coverage information, so that the network device generates the management information according to the acquired second satellite coverage information, and then transmits the management information to the UE, so that at least one of power saving management or mobility management may be successfully performed on the UE according to the management information, accordingly reducing power consumption.

FIG. 12 is a schematic flowchart of a method for acquiring satellite coverage information according to an embodiment of the present disclosure. The method is performed by a UE. As shown in FIG. 12, the method for acquiring the satellite coverage information may include step 1201.

In step 1201, second indication information is transmitted to a network device.

In some examples, in an embodiment of the present disclosure, the second indication information may indicate a capability of the UE, and the capability of the UE may include a capability of the UE to acquire the satellite coverage information. In some examples, the second indication information may be configured for the network device to determine a subject device for acquiring the satellite coverage information, where the subject device is the UE or the network device.

In some examples, in an embodiment of the present disclosure, the UE transmits the second indication information to the network device, so that the network device may determine the capability of the UE (that is, the capability of the UE to acquire the satellite coverage information) according to the second indication information, and determine the subject device for acquiring the satellite coverage information according to the capability of the UE and a capability of the network device (that is, a capability of the network device to acquire the satellite coverage information), where the subject device may be the UE or the network device. Therefore, the satellite coverage information may be subsequently acquired according to the determined subject device, to further generate management information according to the acquired satellite coverage information, to ensure that at least one of power saving management or mobility management may be successfully performed on the UE according to the management information, accordingly reducing power consumption.

For detailed descriptions of the step 1201, refer to the descriptions in the embodiment in FIG. 2a.

In some examples, in this implementation or embodiment, without contradiction, each step may be independent, randomly combined or exchanged in order, and may be randomly combined with another implementation or embodiment.

In conclusion, in the method for acquiring the satellite coverage information according to embodiments of the present disclosure, the UE transmits the second indication information to the network device, so that the network device determines the subject device for acquiring the satellite coverage information from the network device and the UE according to the second indication information, and acquires the satellite coverage information according to a decision result, to ensure the successful acquisition of the satellite coverage information, and ensure that at least one of power saving management or mobility management may be successfully performed according to the satellite coverage information subsequently, accordingly reducing power consumption.

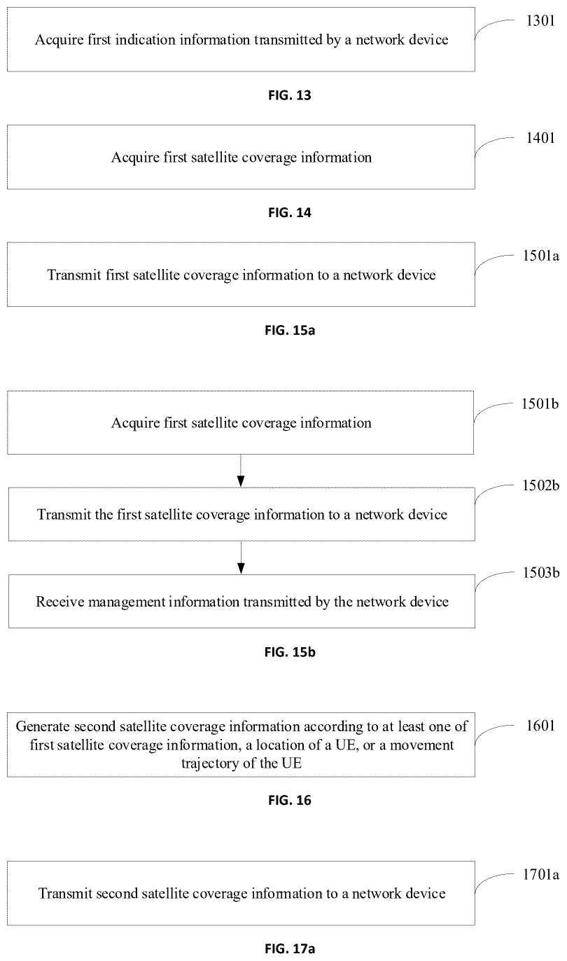

FIG. 13 is a schematic flowchart of a method for acquiring satellite coverage information according to an embodiment of the present disclosure. The method is performed by a UE. As shown in FIG. 13, the method for acquiring the satellite coverage information may include step 1301.

In step 1301, first indication information transmitted by a network device is acquired.

In some examples, the first indication information may indicate the UE to acquire the satellite coverage information.

In some examples, in an embodiment of the present disclosure, the first indication information may be transmitted to the UE by the network device in a case where the network device determines that a subject device for acquiring the satellite coverage information is the UE.

For detailed descriptions of the step 1301, refer to the descriptions in the embodiment in FIG. 2a.

In some examples, in this implementation or embodiment, without contradiction, each step may be independent, randomly combined or exchanged in order, and may be randomly combined with another implementation or embodiment.

In conclusion, in the method for acquiring the satellite coverage information according to embodiments of the present disclosure, the UE receives the first indication information transmitted by the network device, and the UE may determine at least one of first satellite coverage information, second satellite coverage information, or management information according to the first indication information, and then transmit the determined information to the network device, so that the network device may finally generate the management information according to at least one of the acquired first satellite coverage information or the acquired second satellite coverage information, or the network device may perform authorization on the acquired management information, to ensure that at least one of power saving management or mobility management may be successfully performed according to the management information subsequently, accordingly reducing power consumption.

FIG. 14 is a schematic flowchart of a method for acquiring satellite coverage information according to an embodiment of the present disclosure. The method is performed by a UE. As shown in FIG. 14, the method for acquiring the satellite coverage information may include step 1401.

In step 1401, first satellite coverage information is acquired.

For detailed descriptions of the step 1401, refer to the descriptions in the embodiment in FIG. 2a.

In some examples, in this implementation or embodiment, without contradiction, each step may be independent, randomly combined or exchanged in order, and may be randomly combined with another implementation or embodiment.

In conclusion, in the method for acquiring the satellite coverage information according to embodiments of the present disclosure, the UE acquires the first satellite coverage information, so that the UE transmits the first satellite coverage information to the network device, or the UE determines at least one of second satellite coverage information or management information according to the first satellite coverage information, and transmits at least one of the second satellite coverage information or the management information to the network device, so that the network device may finally generate the management information according to at least one of the acquired first satellite coverage information or the acquired second satellite coverage information, or the network device may perform authorization on the acquired management information, to ensure that at least one of power saving management or mobility management may be successfully performed according to the management information subsequently, accordingly reducing power consumption.

FIG. 15a is a schematic flowchart of a method for acquiring satellite coverage information according to an embodiment of the present disclosure. The method is performed by a UE. As shown in FIG. 15a, the method for acquiring the satellite coverage information may include step 1501a.

In step 1501a, first satellite coverage information is transmitted to a network device.

For detailed descriptions of the step 1501a, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

FIG. 15b is a schematic flowchart of a method for acquiring satellite coverage information according to an embodiment of the present disclosure. The method is performed by a UE. As shown in FIG. 15b, the method for acquiring the satellite coverage information may include steps 1501b to 1503b.

In step 1501b, first satellite coverage information is acquired.

In step 1502b, the first satellite coverage information is transmitted to a network device.

In step 1503b, management information transmitted by the network device is received.

For detailed descriptions of the steps 1501b to 1503b, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE transmits the first satellite coverage information to the network device, so that the network device may finally generate the management information according to the first satellite coverage information and transmit the management information to the UE, to ensure that at least one of power saving management or mobility management may be successfully performed on the UE according to the management information subsequently, accordingly reducing power consumption.

FIG. 16 is a schematic flowchart of a method for acquiring satellite coverage information according to an embodiment of the present disclosure. The method is performed by a UE. As shown in FIG. 16, the method for acquiring the satellite coverage information may include step 1601.

In step 1601, second satellite coverage information is generated according to at least one of first satellite coverage information, a location of the UE, or a movement trajectory of the UE.

For detailed descriptions of the step 1601, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE may determine the second satellite coverage information according to the first satellite coverage information, and transmit the second satellite coverage information to the network device, so that the network device may determine management information according to the second satellite coverage information, so that at least one of power saving management or mobility management may be successfully performed on the UE according to the management information subsequently, accordingly reducing power consumption.

FIG. 17a is a schematic flowchart of a method for acquiring satellite coverage information according to an embodiment of the present disclosure. The method is performed by a UE. As shown in FIG. 17a, the method for acquiring the satellite coverage information may include step 1701a.

In step 1701a, second satellite coverage information is transmitted to a network device.

For detailed descriptions of the step 1701a, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE transmits the second satellite coverage information to the network device, so that the network device may finally generate management information according to the second satellite coverage information and transmit the management information to the UE, to ensure that at least one of power saving management or mobility management may be successfully performed on the UE according to the management information subsequently, accordingly reducing power consumption.

FIG. 17b is a schematic flowchart of a method for acquiring satellite coverage information according to an embodiment of the present disclosure. The method is performed by a UE. As shown in FIG. 17b, the method for acquiring the satellite coverage information may include steps 1701b to 1704b.

In step 1701b, first satellite coverage information is acquired.

In step 1702b, second satellite coverage information is generated according to at least one of the first satellite coverage information, a location of a UE, or a movement trajectory of the UE.

In step 1703b, the second satellite coverage information is transmitted to a network device.

In step 1704b, management information transmitted by the network device is acquired.

For detailed descriptions of the steps 1701b to 1704b, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE transmits the second satellite coverage information to the network device, so that the network device may finally generate the management information according to the second satellite coverage information and transmit the management information to the UE, to ensure that at least one of power saving management or mobility management may be successfully performed on the UE according to the management information subsequently, accordingly reducing power consumption.

FIG. 17c is a schematic flowchart of a method for acquiring satellite coverage information according to an embodiment of the present disclosure. The method is performed by a UE. As shown in FIG. 17c, the method for acquiring the satellite coverage information may include step 1701c to 1703c.

In step 1701c, second satellite coverage information is acquired.

In step 1702c, the second satellite coverage information is transmitted to a network device.

In step 1703c, management information transmitted by the network device is acquired.

For detailed descriptions of the steps 1701c to 1703c, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE transmits the second satellite coverage information to the network device, so that the network device may finally generate the management information according to the second satellite coverage information and transmit the management information to the UE, to ensure that at least one of power saving management or mobility management may be successfully performed on the UE according to the management information subsequently, accordingly reducing power consumption.

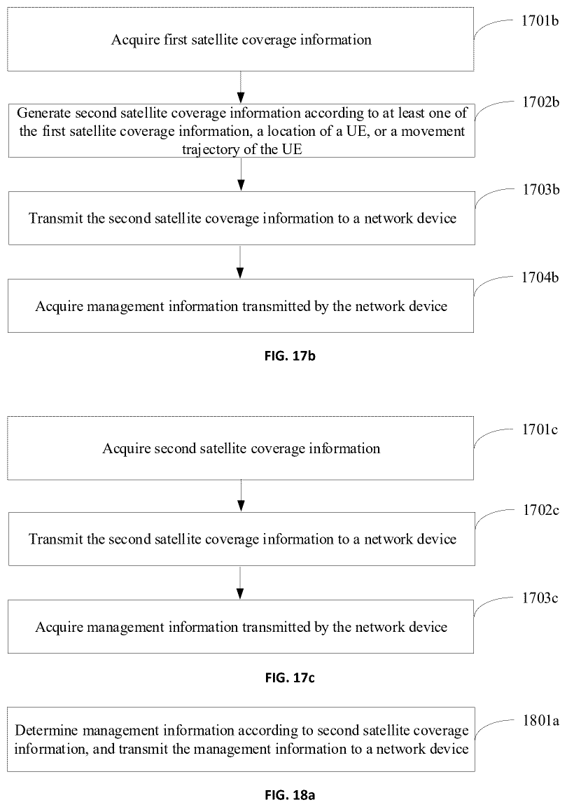

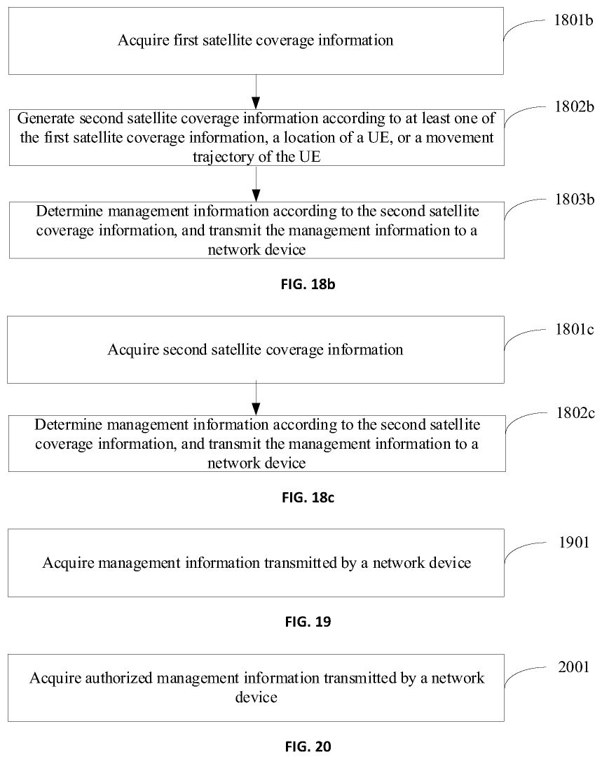

FIG. 18a is a schematic flowchart of a method for acquiring satellite coverage information according to an embodiment of the present disclosure. The method is performed by a UE. As shown in FIG. 18a, the method for acquiring the satellite coverage information may include step 1801a.

In step 1801a, management information is determined according to second satellite coverage information, and the management information is transmitted to a network device.

For detailed descriptions of the step 1801a, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE determines the management information and transmits the management information to the network device, so that the network device may perform authorization on the acquired management information, to ensure that at least one of power saving management or mobility management may be successfully performed according to the management information subsequently, accordingly reducing power consumption.

FIG. 18b is a schematic flowchart of a method for acquiring satellite coverage information according to an embodiment of the present disclosure. The method is performed by a UE. As shown in FIG. 18b, the method for acquiring the satellite coverage information may include steps 1801b to 1803b.

In step 1801b, first satellite coverage information is acquired.

In step 1802b, second satellite coverage information is generated according to at least one of the first satellite coverage information, a location of the UE, or a movement trajectory of the UE.

In step 1803b, management information is determined according to the second satellite coverage information, and the management information is transmitted to a network device.

For detailed descriptions of the steps 1801b to 1803b, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE determines the management information and transmits the management information to the network device, so that the network device may perform authorization on the acquired management information, to ensure that at least one of power saving management or mobility management may be successfully performed according to the management information subsequently, accordingly reducing power consumption.

FIG. 18c is a schematic flowchart of a method for acquiring satellite coverage information according to an embodiment of the present disclosure. The method is performed by a UE. As shown in FIG. 18c, the method for acquiring the satellite coverage information may include steps 1801c to 1802c.

In step 1801c, second satellite coverage information is acquired.

In step 1802c, management information is determined according to the second satellite coverage information, and the management information is transmitted to a network device.

For detailed descriptions of the steps 1801c to 1802c, refer to the content of embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE determines the management information and transmits the management information to the network device, so that the network device may perform authorization on the acquired management information, to ensure that at least one of power saving management or mobility management may be successfully performed according to the management information subsequently, accordingly reducing power consumption.

FIG. 19 is a schematic flowchart of a method for acquiring satellite coverage information according to an embodiment of the present disclosure. The method is performed by a UE. As shown in FIG. 19, the method for acquiring the satellite coverage information may include step 1901.

In step 1901, management information transmitted by a network device is acquired.

For detailed descriptions of the step 1901, refer to the content of embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE acquires the management information transmitted by the network device, to ensure that at least one of power saving management or mobility management may be successfully performed on the UE according to the management information subsequently, accordingly reducing power consumption.

FIG. 20 is a schematic flowchart of a method for acquiring satellite coverage information according to an embodiment of the present disclosure. The method is performed by a UE. As shown in FIG. 20, the method for acquiring the satellite coverage information may include step 2001.

In step 2001, authorized management information transmitted by a network device is acquired.

For detailed descriptions of the step 2001, refer to the content of the embodiment in FIG. 2a.

In some examples, in this implementation or embodiment, without contradiction, each step may be independent, randomly combined or exchanged in order, and optional methods or optional examples may be randomly combined and may be randomly combined with another implementation or embodiment.

In conclusion, in the method for acquiring the satellite coverage information according to embodiments of the present disclosure, the UE acquires the authorized management information transmitted by the network device, to ensure that at least one of power saving management or mobility management may be successfully performed on the UE according to the authorized management information subsequently, accordingly reducing power consumption.

In some examples, in some embodiments, the steps 201a, 201b, and 201c may be combined; in some embodiments, the steps 201d, 201e, and 201f may be combined; in some embodiments, the step 701, the step 802, and the step 803 may be combined; in some embodiments, the step 1201 and the step 1301 may be combined; in some embodiments, the step 1801b, the step 1802b, the step 1803b, and the step 2001 may be combined; and in some embodiments, the step 1801c, the step 1802c, and the step 2001 may be combined.

In some examples, in an embodiment of the present disclosure, without contradiction, any steps in any embodiments in FIG. 2a to FIG. 20 may be combined.

The following describes an example of an embodiment of the present disclosure.

In some examples, a network determines to acquire satellite coverage information (that is, the foregoing first satellite coverage information) for the UE in satellite access according to at least one of the following information, including acquiring the satellite coverage information by the UE or acquiring the satellite coverage information by the network:
an indication of the capability of the UE to acquire satellite coverage information;
the capability of acquiring the satellite coverage information supported by the network;
the capability of the network to acquire a location of the UE; or
the capability of the network to acquire a movement trajectory of the UE, where the movement trajectory is the location information of the UE at a predetermined time point.

In some examples, before the network makes the decision, the method also includes: the UE provides the capability indication to the network (AMF/MME) in a case where the capability of acquiring the satellite coverage information is supported by the UE.

In some examples, the UE may provide the indication in a registration request, a registration update request, a service request message, or a protocol data unit (PDU) session operation request.

In some examples, an indication of acquiring the satellite coverage information by the UE is returned to the UE in a case where the network determines that the UE is to acquire the satellite coverage information.

In some examples, the network may provide the indication in a registration response, a registration update response, a PDU session establishment/modification response, or a user configuration update.

In some examples, the UE acquires the satellite coverage information and generates UE-related satellite coverage information according to the satellite coverage information and at least one of location information or a movement trajectory of the UE.

In some examples, the network acquires the satellite coverage information or UE-related satellite coverage information (that is, the foregoing second satellite coverage information) in a case where the network determines that the network is to acquire the satellite coverage information.

In some examples, the network further generates the UE-related satellite coverage information according to the satellite coverage information, a location of the UE, or the movement trajectory of the UE in a case where the network acquires the satellite coverage information.

In some examples, the UE-related satellite coverage information includes at least one of the following information:
a time point at which the UE has the satellite signal coverage;
a period in which the UE has the satellite signal coverage;
a time point at which the UE has no satellite signal coverage; or
UE unreachability period (a period in which the UE has no satellite signal coverage).

In some examples, the UE generates the UE-related satellite coverage information according to the satellite coverage information and at least one of the location of the UE or the movement trajectory of the UE, and generates a power saving parameter and a NAS timer (the power saving parameter and the NAS timer are the foregoing management information) according to the UE-related satellite coverage information.

In some examples, the UE transmits the power saving parameter and the NAS timer to the network.

In some examples, the UE generates the UE-related satellite coverage information according to the satellite coverage information and at least one of the location of the UE or the movement trajectory of the UE, and transmits the UE-related satellite coverage information to the network. The network generates the power saving parameter and the NAS timer according to the UE-related satellite coverage information.

In some examples, the UE transmits the satellite coverage information to the network, and the network generates the UE-related satellite coverage information according to the satellite coverage information and at least one of the location of the UE or a movement trajectory of the UE, and further generates the power saving parameter and the NAS timer according to the UE-related satellite coverage information.

In some examples, the network generates the power saving parameter and the NAS timer according to the UE-related satellite coverage information.

In some examples, the network transmits the power saving parameter and the NAS timer to the UE.

In some examples, the power saving parameter and the NAS timer are configured to ensure that the UE remains in a power saving mode during a period without satellite signal coverage, and initiates communication with the network as the satellite signal coverage is resumed. The NAS timer includes a periodic registration update timer. The power saving parameter include an eDRX parameter, a PSM parameter, and the like.

In some examples, the following are specific embodiments of the method in the present disclosure.

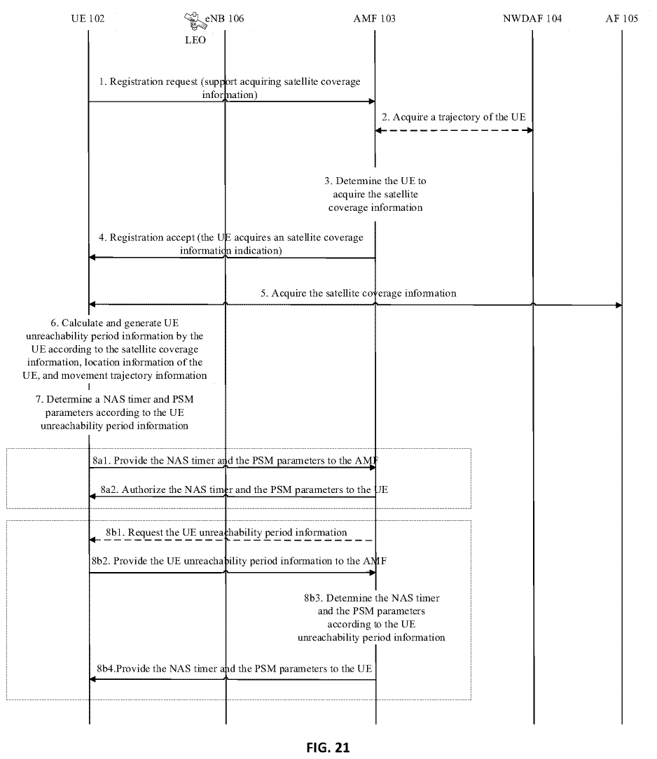

FIG. 21 is an interactive schematic diagram of a method for acquiring satellite coverage information according to an embodiment of the present disclosure. As shown in FIG. 21, the method for acquiring the satellite coverage information may include steps 1 to 8b4.
1. A UE 102 accesses an eNodeB (eNB) 106 via a satellite in the low Earth orbit (LEO), so that the UE 102 accesses a 5GC network and initiates an access registration procedure. In a case where the UE 102 supports acquiring the satellite coverage information, a registration request message transmitted to an AMF 103 by the UE 102 includes an indication of a capability of acquiring the satellite coverage information (that is, the foregoing second indication information).
2. The AMF 103 (that is, the foregoing network device 101) receives a registration request from the UE 102. During processing the registration procedure of the UE 102, the AMF 103 may further acquire a movement trajectory analysis result of the UE 102 from an NWDAF 104. In a case where there is the analysis result, the NWDAF 104 may provide the analysis result to the AMF.
3. The AMF 103 determines a subject device to support acquiring the satellite coverage information, that is, the AMF 103 determines the UE 102 to acquire the satellite coverage information, according to an indication of the capability of acquiring the satellite coverage information supported by the UE 102, whether the AMF 103 supports the capability of acquiring satellite coverage, whether the trajectory analysis result of the UE 102 may be acquired, and the like.
4. The AMF 103 returns a registration accept message to the UE 102, and causes an indication of acquiring the satellite coverage information by the UE 102 (that is, the foregoing first indication information) included in the registration accept message.
5. The UE 102 learns that the UE 102 needs to acquire the satellite coverage information according to a notification returned by the AMF 103, then the UE 102 acquires first satellite coverage information from an AF 105 or a management server responsible for satellite operation information.
6. The UE 102 calculates and generates second satellite coverage information according to the first satellite coverage information, location information of the UE 102, and movement trajectory information. The second satellite coverage information is UE-related satellite coverage information and includes at least one of the following information: a time point at which the UE 102 has satellite signal coverage; a period in which the UE 102 has the satellite signal coverage; a time point at which the UE 102 has no satellite signal coverage; or a period in which the UE 102 has no satellite signal coverage. The period in which the UE 102 has no satellite signal coverage is UE unreachability period information.
7. The UE 102 further sets a NAS timer (for example, a periodic registration update timer) and PSM parameters (for example, eDRX parameters, and the like) according to the UE unreachability period information.
8a1. The UE 102 provides the NAS timer and the PSM parameters to the AMF 103 and requests AMF 103 authorization.
8a2. The AMF 103 returns an authorization result and the UE 102 executes authorized parameters. This ensures that the UE 102 remains in a power saving mode during a period without satellite signal coverage.

The procedure of 8a1-8a2 may alternatively be replaced by steps 8b1 to 8b4.
8b1 to 8b2. The UE 102 transmits the UE unreachability period information to the AMF 103 upon AMF 103 request by the network device.
8b3. The AMF 103 generates the NAS timer (for example, the periodic registration update timer) and the PSM parameters (for example, the eDRX parameters, and the like) according to the UE unreachability period information.
8b4. The AMF 103 provides the NAS timer and the PSM parameters to the UE 102. This ensures that the UE 102 remains in the power saving mode during the period without satellite signal coverage.

In some examples, in some embodiments, the steps 5 to 6 and the steps 8b1 to 8b4 may be combined. In some embodiments, the step 5 and the steps 8b3 to 8b4 may be combined. In some embodiments, the AMF 103 may further acquire the movement trajectory analysis result of the UE 102 from the NWDAF 104 in the step 2 may alternatively be performed after the step 3.

In some examples, in this implementation or embodiment, without contradiction, each step in FIG. 21 may be independent, randomly combined or exchanged in order, and optional methods or optional examples may be randomly combined and may be randomly combined with another implementation or embodiment.

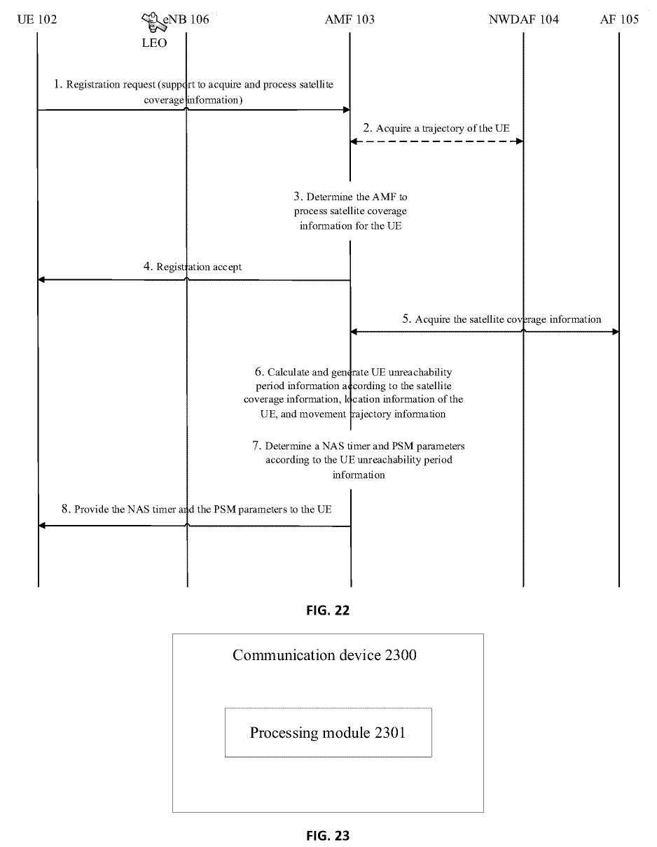

FIG. 22 is an interactive schematic diagram of a method for acquiring satellite coverage information according to an embodiment of the present disclosure. As shown in FIG. 22, the method for acquiring the satellite coverage information may include steps 9-17.
9. A UE 102 accesses an eNodeB (eNB) 106 via a satellite in the low Earth orbit (LEO), so that the UE 102 accesses a 5GC network and initiates an access registration procedure. In a case where the UE 102 supports a capability of acquiring and processing the satellite coverage information, a registration request message transmitted to an AMF 103 by the UE 102 includes an indication of supporting the satellite coverage information acquiring and processing (that is, the foregoing second indication information). The capability of acquiring and processing the satellite coverage information indicates that the UE 102 may acquire first satellite coverage information, and calculate and generate second satellite coverage information including a UE unreachability period according to the satellite coverage information, location information of the UE 102, and a movement trajectory of the UE 102. The UE unreachability period refers to a start time and duration in which the UE 102 has no satellite coverage at a specified location (for example, a current location or a predetermined location).
10. The AMF 103 receives a registration request from the UE 102. During processing the registration procedure of the UE 102, the AMF 103 may further acquire a movement trajectory analysis result of the UE 102 from an NWDAF 104. In a case where there is the analysis result, the NWDAF 104 may provide the analysis result to the AMF 103.
11. The AMF 103 determines a subject device to acquire and process the satellite coverage information, that is, the AMF 103 determines the AMF 103 to acquire and process the satellite coverage information, according to the capability of acquiring and processing the satellite coverage information supported by the UE 102, whether the AMF 103 supports the capability of acquiring and processing satellite coverage, whether the trajectory analysis result of the UE 102 may be acquired, and the like.
12. The AMF 103 returns a registration accept message to the UE 102.
13. The AMF 103 acquires first satellite coverage information from an AF 105 or a management server responsible for satellite operation information.
14. The AMF 103 calculates and generates the second satellite coverage information including UE unreachability period information according to the first satellite coverage information, location information of the UE 102, and movement trajectory information. The UE unreachability period information includes a period in which the UE 102 has no satellite signal coverage at a specified location.
15. The AMF 103 further sets a NAS timer (for example, a periodic registration update timer) and PSM parameters (for example, eDRX parameters, and the like) according to the UE unreachability period information.
16. The AMF 103 provides the NAS timer and the PSM parameters to the UE 102. This ensures that the UE 102 remains in a power saving mode during a period without satellite signal coverage.
17. The steps 13-14 may alternatively be replaced by the following steps: The AMF 103 directly acquires UE-related satellite coverage information (that is, the second satellite coverage information) from the AF 105.

In some examples, the steps 13, 14 and 17 may be combined. In some embodiments, the AMF 103 may further acquire the movement trajectory analysis result of the UE 102 from the NWDAF 104 in the step 10 may alternatively be performed after the step 11.

In some examples, in this implementation or embodiment, without contradiction, each step in FIG. 22 may be independent, randomly combined or exchanged in order, and optional methods or optional examples may be randomly combined and may be randomly combined with another implementation or embodiment.

FIG. 23 is a schematic structural diagram of a communication device 2300 according to an embodiment of the present disclosure. As shown in FIG. 23, the communication device 2300 may include:
a processing module 2301 configured to determine a subject device for acquiring satellite coverage information according to at least one of a capability of a user equipment (UE) or the capability of a network device, where the subject device is the UE or the network device, the capability of the UE includes a capability of the UE to acquire the satellite coverage information, and the capability of the network device includes a capability of the network device to acquire the satellite coverage information.

In conclusion, in the communication device according to embodiments of the present disclosure, the network device determines the subject device for acquiring the satellite coverage information from the network device and the UE according to at least one of the capability of the UE or the capability of the network device, so that the satellite coverage information may be subsequently acquired according to a decision result, to ensure the successful acquisition of the satellite coverage information, and ensure that management information may be successfully generated according to the satellite coverage information, and at least one of power saving management or mobility management may be successfully performed according to the management information subsequently, accordingly reducing power consumption.

In some examples, in an embodiment of the present disclosure, the satellite coverage information includes at least one of first satellite coverage information or second satellite coverage information, where
the first satellite coverage information indicates at least one of the following: a satellite signal coverage condition of a satellite network currently accessed by the UE, or a satellite signal coverage condition of at least one available satellite network; and
the second satellite coverage information indicates a satellite signal coverage condition of the UE.

In some examples, in an embodiment of the present disclosure, the communication device 2300 is further configured to:
transmit first indication information to the UE in a case where the determined subject device is the UE, where the first indication information instructs the UE to acquire the satellite coverage information.

In some examples, in an embodiment of the present disclosure, the communication device 2300 is further configured to:
acquire first satellite coverage information transmitted by the UE.

In some examples, in an embodiment of the present disclosure, the communication device 2300 is further configured to:
acquire the satellite coverage information by the network device in a case where the determined subject device is the network device.

In some examples, in an embodiment of the present disclosure, the communication device 2300 is further configured to:
acquire first satellite coverage information.

In some examples, in an embodiment of the present disclosure, the communication device is further configured to:
determine second satellite coverage information according to at least one of the first satellite coverage information, a location of the UE, or a movement trajectory of the UE.

In some examples, in an embodiment of the present disclosure, the communication device 2300 is further configured to:
acquire second satellite coverage information transmitted by the UE.

In some examples, in an embodiment of the present disclosure, the communication device 2300 is further configured to:
acquire second satellite coverage information.

In some examples, in an embodiment of the present disclosure, the communication device 2300 is further configured to:
generate management information according to the second satellite coverage information, and transmit the management information to the UE.

In some examples, in an embodiment of the present disclosure, the communication device 2300 is further configured to:
acquire management information transmitted by the UE, where the management information enables the UE to maintain a power saving mode during a period without satellite signal coverage and to maintain a network connection state during a period with the satellite signal coverage.

In some examples, in an embodiment of the present disclosure, the communication device 2300 is further configured to:
perform authorization on the management information; and
return authorized management information to the UE in a case where the authorization passes.

In some examples, in an embodiment of the present disclosure, the communication device 2300 is further configured to:
acquire second indication information transmitted by the UE, where the second indication information indicates the capability of the UE.

In some examples, in an embodiment of the present disclosure, the second satellite coverage information indicates a satellite coverage condition of the UE at a specified location.

In some examples, in an embodiment of the present disclosure, the second satellite coverage information includes at least one of the following information:
a time point at which the UE has satellite signal coverage;
a period in which the UE has the satellite signal coverage;
a time point at which the UE has no satellite signal coverage; or
a period in which the UE has no satellite signal coverage.

In some examples, in an embodiment of the present disclosure, the management information includes at least one of the following:
an extended discontinuous reception (eDRX) parameter in a connection management idle state (CM-IDLE);
a parameter for configuring a mobile initiated connection only (MICO) mode;
a parameter for configuring a power saving mode (PSM); or
timing duration of a periodic registration timer.

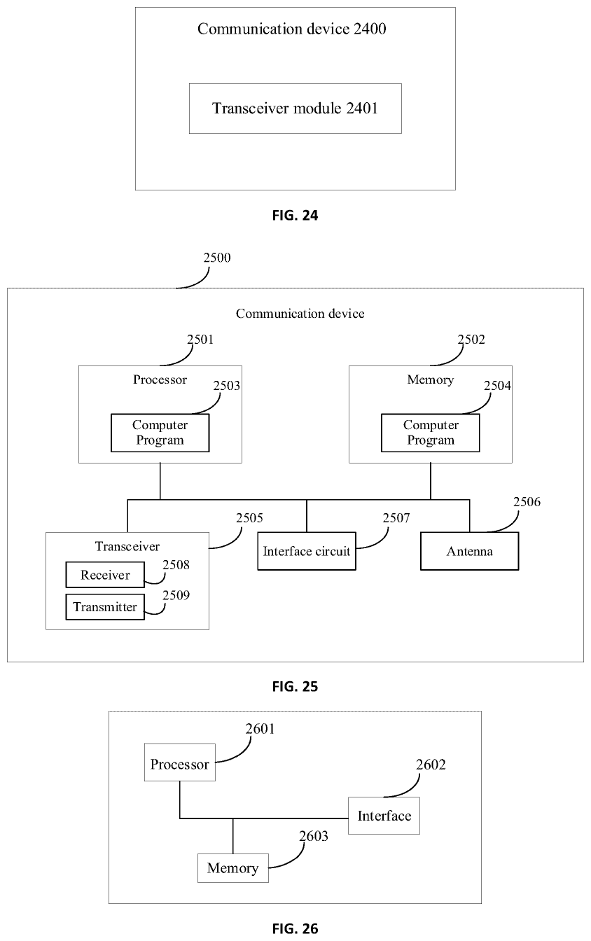

FIG. 24 is a schematic structural diagram of a communication device 2400 according to an embodiment of the present disclosure. As shown in FIG. 24, the communication device 2400 may include:
a transceiver module 2401 configured to transmit second indication information to a network device, where the second indication information indicates a capability of a UE, the capability of the UE includes a capability of the UE to acquire the satellite coverage information, the second indication information instructs the network device to determine a subject device for acquiring the satellite coverage information, and the subject device is the UE or the network device.

In conclusion, in the communication device according to embodiments of the present disclosure, the UE transmits the second indication information to the network device, so that the network device determines the subject device for acquiring satellite coverage information from the network device and the UE according to the second indication information, and acquires the satellite coverage information according to a decision result, to ensure the successful acquisition of the satellite coverage information, and ensure that at least one of power saving management or mobility management may be successfully performed according to the satellite coverage information subsequently, accordingly reducing power consumption.

In some examples, in an embodiment of the present disclosure, the satellite coverage information includes at least one of first satellite coverage information or second satellite coverage information, where
the first satellite coverage information indicates at least one of the following: a satellite signal coverage condition of a satellite network currently accessed by the UE, or a satellite signal coverage condition of at least one available satellite network; and
the second satellite coverage information indicates a satellite signal coverage condition of the UE.

In some examples, in an embodiment of the present disclosure, the communication device 2400 is further configured to:
acquire first indication information transmitted by the network device, where the first indication information instructs the UE to acquire the satellite coverage information.

In some examples, in an embodiment of the present disclosure, the communication device 2400 is further configured to:
acquire first satellite coverage information.

In some examples, in an embodiment of the present disclosure, the communication device 2400 is further configured to:
transmit the first satellite coverage information to the network device.

In some examples, in an embodiment of the present disclosure, the communication device 2400 is further configured to:
generate second satellite coverage information according to at least one of the first satellite coverage information, a location of the UE, or a movement trajectory of the UE.

In some examples, in an embodiment of the present disclosure, the communication device 2400 is further configured to:
transmit the second satellite coverage information to the network device.

In some examples, in an embodiment of the present disclosure, the communication device 2400 is further configured to:
determine management information according to the second satellite coverage information, and transmit the management information to the network device, where the management information enables the UE to maintain a power saving mode during a period without satellite signal coverage and to maintain a network connection state during a period with satellite signal coverage.

In some examples, in an embodiment of the present disclosure, the communication device 2400 is further configured to:
acquire the management information transmitted by the network device.

In some examples, in an embodiment of the present disclosure, the communication device 2400 is further configured to:
acquire authorized management information transmitted by the network device.

In some examples, in an embodiment of the present disclosure, the second satellite coverage information indicates a satellite coverage condition of the UE at a specified location.

In some examples, in an embodiment of the present disclosure, the second satellite coverage information includes at least one of the following information:
a time point at which the UE has satellite signal coverage;
a period in which the UE has the satellite signal coverage;
a time point at which the UE has no satellite signal coverage; or
a period in which the UE has no satellite signal coverage.

In some examples, in an embodiment of the present disclosure, the management information includes at least one of the following:
an extended discontinuous reception (eDRX) parameter in a connection management idle state (CM-IDLE);
a parameter for configuring a mobile initiated connection only (MICO) mode;
a parameter for configuring a power saving mode (PSM); or
timing duration of a periodic registration timer.

FIG. 25 is a schematic structural diagram of a communication device 2500 according to another embodiment of this application. The communication device 2500 may be a network device, a terminal. Alternatively, the communication device 2500 may be a chip, a chip system, or a processor that supports a network device in implementing the foregoing method. Alternatively, the communication device 2500 may be a chip, a chip system, or a processor that supports a terminal in implementing the foregoing method. The communication device may be configured to implement the method described in the foregoing method embodiment. For details, refer to descriptions in the foregoing method embodiment.

The communication device 2500 may include one or more processors 2501. The processor 2501 may be a general-purpose processor, a dedicated processor, or the like. For example, the processor may be a baseband processor or a central processing unit. The baseband processor may be configured for processing a communication protocol and communication data, and the central processing unit may be configured for controlling the communication device (for example, a base station, a baseband chip, a terminal, a terminal chip, a DU or CU, or the like), executing a computer program, and processing data of the computer program.

In some examples, the communication device 2500 may further include one or more memories 2502 storing a computer program 2504, and the processor 2501 executes the computer program 2504, to cause the communication device 2500 to perform the method according to the foregoing method embodiment. In some examples, the memory 2502 may further store data. The communication device 2500 and the memory 2502 may be disposed separately, or may be integrated.

In some examples, the communication device 2500 may further include a transceiver 2505 and an antenna 2506. The transceiver 2505 may be referred to as a transceiver unit, a transceiver machine, a transceiver circuit, or the like, and the transceiver 2505 is configured for implementing a transceiver function. The transceiver 2505 may include a receiver 2508 and a transmitter 2509. The receiver 2508 may be referred to as a receiver machine, a receiving circuit, or the like, and the receiver 2508 is configured for implementing a receiving function. The transmitter 2509 may be referred to as a transmitter machine, a transmitting circuit, or the like, and the transmitter 2509 is configured for implementing a transmitting function.

In some examples, the communication device 2500 may further include one or more interface circuits 2507. The interface circuit 2507 is configured to: receive code instructions and transmit the code instructions to the processor 2501. The processor 2501 runs the code instructions, to cause the communication device 2500 to perform the method according to the foregoing method embodiment.

In an implementation, the processor 2501 may include a transceiver for implementing receiving and transmitting functions. For example, the transceiver may be a transceiver circuit, an interface, or an interface circuit. The transceiver circuit, the interface, or the interface circuit configured for implementing the receiving and transmitting functions may be separate or integrated. The transceiver circuit, the interface, or the interface circuit may be configured for reading and writing codes/data, or the transceiver circuit, the interface, or the interface circuit may be configured for signal transmission or transfer.

In an implementation, the processor 2501 may store a computer program 2503, and the computer program 2503 is run on the processor 2501, to cause the communication device 2500 to perform the method according to the foregoing method embodiment. The computer program 2503 may be embedded in the processor 2501. In this case, the processor 2501 may be implemented by hardware.

In an implementation, the communication device 2500 may include a circuit, and the circuit may implement the function of transmitting or receiving or communicating in the foregoing method embodiment. The processor and the transceiver described in this application may be implemented in an integrated circuit (IC), an analog IC, a radio frequency integrated circuit RFIC, a mixed-signal IC, an application-specific integrated circuit (ASIC), a printed circuit board (PCB), an electronic device, or the like. The processor and the transceiver may alternatively be manufactured by using various IC technologies, for example, a complementary metal oxide semiconductor (CMOS), an N-channel metal-oxide-semiconductor (nMetal-oxide-semiconductor, NMOS), a P-channel metal oxide semiconductor (positive channel metal oxide semiconductor, PMOS), a bipolar junction transistor (BJT), a bipolar CMOS (BiCMOS), silicon germanium (SiGe), gallium arsenide (GaAs), and the like.

The communication device described in the foregoing embodiments may be a network device or a terminal, but the scope of the communication device described in this application is not limited to this, and a structure of the communication device may not be limited by FIG. 25. The communication device may be an independent device, or may be a part of a larger device. For example, the communication device may be:
(1) an independent integrated circuit IC, a chip, a chip system, or a subsystem;
(2) a combination of one or more ICs, in some examples, the IC combination may also include a storage component for storing data or a computer program;
(3) an ASIC, for example, a modem (Modem);
(4) a module that may be embedded in another device;
(5) a receiver, a terminal, an intelligent terminal, a cellular phone, a wireless device, a hand-held device, a mobile unit, an in-vehicle device, a network device, a cloud device, an artificial intelligence device, or the like; or
(6) another device.

For a case where the communication device may be a chip or a chip system, refer to the schematic structural diagram of a chip shown in FIG. 26. The chip shown in FIG. 26 includes a processor 2601 and an interface 2602. In some examples, there may be one or more processors 2601, and there may be a plurality of interfaces 2602.

In some examples, the chip further includes a memory 2603, and the memory 2603 is configured for storing a necessary computer program and data.

A person skilled in the art may further understand that various illustrative logical blocks and the steps listed in embodiments of this application may be implemented by electronic hardware, computer software, or a combination thereof. Whether such functions are implemented through hardware or software depends on a specific application and design requirements of an entire system. A person skilled in the art may use various methods to implement the functions for each particular application, but it is to not be considered that the implementation goes beyond the scope of embodiments of this application.

This application further provides a non-transitory computer readable storage medium storing instructions. When the instructions are executed by the computer, functions of any one of the foregoing method embodiments are implemented.

This application further provides a computer program product. When the computer program product is executed by a computer, functions of any one of the foregoing method embodiments are implemented.

This application further provides a chip system. The chip system includes at least one processor and an interface. The chip system is configured to support a communication device in implementing functions of any one of the foregoing method embodiments, for example, in determining or processing at least one of the data or information involved in the foregoing method. In a possible design, the chip system further includes a memory. The memory is configured to store a computer program and data that are necessary for a source or secondary node. The chip system may include a chip, or may include a chip and another discrete component.

All or some of the foregoing embodiments may be implemented by software, hardware, firmware, or any combination thereof. When software is configured to implement embodiments, all or some of embodiments may be implemented in a form of a computer program product. The computer program product includes one or more computer programs. When the computer program is loaded and executed on a computer, the procedure or functions according to embodiments of this application are all or partially generated. The computer may be a general-purpose computer, a dedicated computer, a computer network, or another programmable device. The computer program may be stored in a computer-readable storage medium or may be transmitted from a computer-readable storage medium to another computer-readable storage medium. For example, the computer program may be transmitted from a website, computer, server, or data center to another website, computer, server, or data center in a wired (for example, a coaxial cable, an optical fiber, or a digital subscriber line (DSL)) or wireless (for example, infrared, radio, and microwave, or the like) manner. The computer-readable storage medium may be any usable medium accessible by the computer, or a data storage device, for example, a server or a data center, integrating one or more usable media. The usable medium may be a magnetic medium (for example, a floppy disk, a hard disk drive, or a magnetic tape), an optical medium (for example, a high definition digital video disc (DVD)), a semiconductor medium (for example, a solid-state drive (SSD)), or the like.

A person of ordinary skill in the art may understand that, various numbers such as first and second in this application are merely configured for differentiation for ease of descriptions, and are not configured to limit the scope of embodiments of this application or represent a sequence.

The at least one in this application may alternatively be described as one or more, and a plurality of may be two, three, four or more. This is not limited in this application. In embodiments of this application, for a technical feature, the technical features are distinguished by using terms “first,” “second,” “third,” “A,” “B,” “C” and “D,” and there is no order of precedence or size between the technical features described by using the terms “first,” “second,” “third,” “A,” “B,” “C”and“D”.

Correspondences shown in tables in this application may be configured or predefined. Values of signals in each table are only examples and may be configured as other values. This is not limited in this application. In configuring a correspondence between information and parameters, it is not necessarily required to configure all correspondences illustrated in the table. For example, in the table in this application, a correspondence shown in some rows may not be configured. For another example, appropriate deformation and adjustments may be made according to the foregoing table, such as splitting, merging, and the like. Names of the parameters shown in titles of the tables may alternatively be other names understandable to the communication device, and the values or representations of the parameters may alternatively be other values or representations understandable to the communication device. In implementing the tables, another data structure may alternatively be used, for example, an array, a queue, a container, a stack, a linear list, a pointer, a linked list, a tree, a graph, a structure, a class, a pile, a hash table, or the like.

The term predefined in this application may be understood as defined, predefined, stored, pre-stored, pre-negotiated, pre-configured, embedded, or pre-burned.

As used herein, the term “processor” may refer to one processor that performs the defined functions or a plurality of processors that collectively perform defined functions, such that the execution of the individual defined functions may be divided amongst such processors.

A person of ordinary skill in the art may be aware that, in combination with examples described in embodiments disclosed in this specification, units and algorithm steps may be implemented by electronic hardware or a combination of computer software and electronic hardware. Whether the functions are performed by hardware or software depends on particular applications and design constraints of the technical solution. A person skilled in the art may use different methods to implement the described functions for each particular application, but it is to not be considered that the implementation goes beyond the scope of this application.

It may be clearly understood by a person skilled in the art that, for the purpose of convenient and brief descriptions, for a detailed working process of the foregoing system, device, and unit, refer to a corresponding process in the foregoing method embodiments. Details are not described in the disclosure again.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. A method for acquiring satellite coverage information, performed by a network device, the method comprising:
determining a subject device for acquiring the satellite coverage information according to at least one of a capability of a user equipment (UE) or a capability of the network device, wherein the subject device is the UE or the network device, the capability of the UE comprises a capability of the UE to acquire the satellite coverage information, and the capability of the network device comprises a capability of the network device to acquire the satellite coverage information.

2. The method according to claim 1, wherein the satellite coverage information comprises at least one of first satellite coverage information or second satellite coverage information;
the first satellite coverage information indicates at least one of: a satellite signal coverage condition of a satellite network currently accessed by the UE, or a satellite signal coverage condition of at least one available satellite network; and
the second satellite coverage information indicates a satellite signal coverage condition of the UE.

3. The method according to claim 2, wherein the method further comprises:
transmitting first indication information to the UE in a case where the determined subject device is the UE, wherein the first indication information instructs the UE to acquire the satellite coverage information; or
wherein the method further comprises:
acquiring the satellite coverage information by the network device in a case where the determined subject device is the network device;
wherein acquiring the satellite coverage information by the network device comprises:
acquiring the first satellite coverage information; or
acquiring the second satellite coverage information.

4. The method according to claim 3, wherein in a case where the determined subject device is the UE, the method further comprises:
acquiring the first satellite coverage information transmitted by the UE; or
acquiring the second satellite coverage information transmitted by the UE.

5-6. (canceled)

7. The method according to claim 2, wherein the method further comprises:
determining the second satellite coverage information according to at least one of the first satellite coverage information, a location of the UE, or a movement trajectory of the UE.

8-9. (canceled)

10. The method according to claim 2, wherein the method further comprises:
generating management information according to the second satellite coverage information, and transmitting the management information to the UE;
wherein the management information comprises at least one of:
an extended discontinuous reception (eDRX) parameter in a connection management idle state (CM-IDLE);
a parameter for configuring a mobile initiated connection only (MICO) mode;
a parameter for configuring a power saving mode (PSM); or
timing duration of a periodic registration timer.

11. The method according to claim 1, wherein in a case where the determined subject device is the UE, the method further comprises:
acquiring management information transmitted by the UE, wherein the management information enables the UE to maintain a power saving mode during a period without satellite signal coverage and to maintain a network connection state during a period with the satellite signal coverage.

12. The method according to claim 11, wherein the method further comprises:
performing authorization on the management information; and
returning authorized management information to the UE in a case where the authorization passes.

13. The method according to claim 1, wherein the method further comprises:
acquiring second indication information transmitted by the UE, wherein the second indication information indicates the capability of the UE.

14. The method according to claim 2, wherein the second satellite coverage information indicates a satellite coverage condition of the UE at a specified location;
wherein the second satellite coverage information comprises at least one of:
a time point at which the UE has satellite signal coverage;
a period in which the UE has the satellite signal coverage;
a time point at which the UE has no satellite signal coverage; or
a period in which the UE has no satellite signal coverage.

15-16. (canceled)

17. A method for acquiring satellite coverage information, performed by a user equipment (UE), the method comprising:
transmitting second indication information to a network device, wherein the second indication information indicates a capability of the UE, the capability of the UE comprises a capability of the UE to acquire the satellite coverage information, the second indication information instructs the network device to determine a subject device for acquiring the satellite coverage information, and the subject device is the UE or the network device.

18. The method according to claim 17, wherein the satellite coverage information comprises at least one of first satellite coverage information or second satellite coverage information;
the first satellite coverage information indicates at least one of: a satellite signal coverage condition of a satellite network currently accessed by the UE, or a satellite signal coverage condition of at least one available satellite network; and
the second satellite coverage information indicates a satellite signal coverage condition of the UE.

19. The method according to claim 18, wherein the method further comprises:
acquiring first indication information transmitted by the network device, wherein the first indication information instructs the UE to acquire the satellite coverage information;
wherein the method further comprises:
acquiring the first satellite coverage information.

20. (canceled)

21. The method according to claim 18, wherein the method further comprises:
transmitting the first satellite coverage information to the network device.

22. The method according to claim 18, wherein the method further comprises:
generating the second satellite coverage information according to at least one of the first satellite coverage information, a location of the UE, or a movement trajectory of the UE.

23. The method according to claim 18, wherein the method further comprises:
transmitting the second satellite coverage information to the network device.

24. The method according to claim 18, wherein the method further comprises:
determining management information according to the second satellite coverage information, and transmitting the management information to the network device, wherein the management information enables the UE to maintain a power saving mode during a period without satellite signal coverage and to maintain a network connection state during a period with satellite signal coverage;
wherein the management information comprises at least one of:
an extended discontinuous reception (eDRX) parameter in a connection management idle state (CM-IDLE);
a parameter for configuring a mobile initiated connection only (MICO) mode;
a parameter for configuring a power saving mode (PSM); or
timing duration of a periodic registration timer.

25. The method according to claim 17, wherein the method further comprises:
acquiring management information transmitted by the network device; or
acquiring authorized management information transmitted by the network device.

26. (canceled)

27. The method according to claim 18, wherein the second satellite coverage information indicates a satellite coverage condition of the UE at a specified location;
wherein the second satellite coverage information comprises at least one of:
a time point at which the UE has satellite signal coverage;
a period in which the UE has the satellite signal coverage;
a time point at which the UE has no satellite signal coverage; or
a period in which the UE has no satellite signal coverage.

28-31. (canceled)

32. A communication device, comprising one or more processors and a memory storing a computer program, wherein the computer program, when executed by the one or more processors, causes the communication device to:
determine a subject device for acquiring the satellite coverage information according to at least one of a capability of a user equipment (UE) or a capability of a network device, wherein the subject device is the UE or the network device, the capability of the UE comprises a capability of the UE to acquire the satellite coverage information, and the capability of the network device comprises a capability of the network device to acquire the satellite coverage information.

33-34. (canceled)
